(19) United States
(12) Patent Application Publication
(10) Pub. No.: US 2026/0128972 A1
(43) Pub. Date: May 7, 2026

(54) BED CONFIGURED TO DETERMINE CONNECTIVITY QUALITY TO BACKEND SERVER

(71) Applicant: Sleep Number Corporation, Minneapolis, MN (US)

(72) Inventors: Sajeev Mayandi, Minneapolis, MN (US); Abhijit Pandey, Santa Clara, CA (US); Faisal Mushtaq, San Diego, CA (US)

(21) Appl. No.: 19/359,871

(22) Filed: Oct. 16, 2025

Related U.S. Application Data
(60) Provisional application No. 63/717,481, filed on Nov. 7, 2024.

(51) Int. Cl. H04L 43/0811; A47C 27/08; A47C 31/00; H04L 43/045

(52) U.S. Cl. CPC H04L 43/0811; A47C 27/082; A47C 31/008; H04L 43/045

(57) ABSTRACT

A controller is configured to receive, from a first server, a command to perform a test to determine a network connectivity level of a bed. The controller is further configured to communicate with a second server responsive to receiving the command to perform the test to determine the network connectivity level of the bed. The controller is further configured to receive, from the second server, data indicating a current connectivity speed for a router at a geographical location of the controller, responsive to communicating with the second server, where the router is in communication with the controller. The controller is further configured to determine a network connectivity level of the bed using one or more set of rules, responsive to receiving the data indicating the current connectivity speed for the router.

### INCORPORATION BY REFERENCE

This application claims priority to U.S. Provisional Application Ser. No. 63/717,481, filed November 7, 2024, the disclosure of which is incorporated by reference in its entirety.

### TECHNICAL FIELD

The present document relates to network connectivity quality for a bed.

### BACKGROUND

In general, a bed is a piece of furniture used as a location to sleep or relax. Many modern beds include a soft mattress on a bed frame. The mattress may include springs, foam material, and/or an air chamber to support the weight of one or more occupants.

### SUMMARY

A bed or other connected devices within a home can experience connectivity issues, for example, Wi-Fi connectivity issues or network speed reduction. Configuring the bed to act as a hub device that can perform self-diagnostic tests to determine a quality of the connectivity between the bed and a background server that supports the features of the bed can be beneficial to isolate issues caused by lack of connectivity.

In one implementation, a system includes a bed, and a controller operably connected to the bed, the controller including a processor and a computer-readable memory, the controller is configured to, receive, from a first server, a command to perform a test to determine a network connectivity level of the bed, responsive to receiving the command to perform the test to determine the network connectivity level of the bed, communicate with a second server, responsive to communicating with the second server, receive, from the second server, data indicating a current connectivity speed for a router at a geographical location of the controller, wherein the router is in communication with the controller, and responsive to receiving the data indicating the current connectivity speed for the router, determine a network connectivity level of the bed using one or more set of rules.

In some aspects, the techniques described herein relate to a system, wherein, receiving, from the first server, the command to perform a test to determine a network connectivity level of the bed comprises receiving a periodic command to perform the test.

In some aspects, the techniques described herein relate to a system, wherein, receiving, from the first server, the command to perform a test to determine a network connectivity level of the bed comprises receiving a command to perform the test in response to detecting a connectivity issue.

In some aspects, the techniques described herein relate to a system, further comprising, communicating the network connectivity level of the bed to the first server, the first server being configured to, compare the network connectivity level of the bed to a network connectivity threshold, responsive to comparing the network connectivity level of the bed to a network connectivity threshold, determine that the network connectivity level is below the network connectivity threshold, and responsive to determining that the network connectivity level is below the network connectivity threshold, provide a recommendation to a user.

In some aspects, the techniques described herein relate to a system, wherein the first server is configured to provide the network connectivity level of the bed to a user.

In some aspects, the techniques described herein relate to a system, wherein providing the connectivity level of the bed to the user comprises visually representing the network connectivity level using multiple colors.

In some aspects, the techniques described herein relate to a system, wherein providing the connectivity level of the bed to the user comprises visually representing the network connectivity level using a graphical representation.

In another implementation, a system includes a bed, a controller connected to the bed, and a server in communication with the controller, the server including a processor and a computer-readable memory, the server configured to, at a first time, receive data indicating a first connectivity speed for the controller, responsive to receiving data indicating the first connectivity speed for the controller, determine a first network connectivity level of the bed using at least one of one or more set of rules, compare the first network connectivity level of the bed to a network connectivity threshold, responsive to comparing the first network connectivity level of the bed to the connectivity threshold, determine that the first network connectivity level of the bed meets the network connectivity threshold, at a second time, after the first time, receive data indicating a second connectivity speed for the controller, responsive to receiving data indicating the second connectivity speed for the controller, determine a second network connectivity level of the bed using the at least one of the one or more set of rules, compare the second network connectivity level of the bed to the network connectivity threshold, responsive to comparing the second networking connectivity level of the bed to the connectivity threshold, determine that the second network connectivity level of the bed does not meet the network connectivity threshold, and responsive to determining that the second network connectivity level of the bed does not meet the network connectivity threshold, communicate a notification to a user device of a user associated with the bed, wherein the notification indicates that the network connectivity level of the bed is below the threshold and includes a recommendation to the user.

In some aspects, the techniques described herein relate to a system, further comprising responsive to determining that the first network connectivity level of the bed meets the network connectivity threshold, initiate a test communication with the controller, responsive to initiating the test communication with the controller, determine that the server is not connecting to the controller, and responsive to determining that the server is not connecting to the controller, communicate a notification to a help desk server indicating that the connectivity level of the bed meets the network connectivity threshold but the server is not connecting to the controller.

In some aspects, the techniques described herein relate to a system wherein communicating a notification, to the user device of the user associated with the bed, including the recommendation to the user, comprises communicating a notification recommending the user to reset a router at a geographical location of the bed.

In some aspects, the techniques described herein relate to a system wherein communicating a notification, to the user device of the user associated with the bed, including a the recommendation to the user, comprises communicating a notification recommending the user move a location of a router at a geographical location of the bed.

In some aspects, the techniques described herein relate to a system further comprising responsive to determining that the first network connectivity level of the bed meets the network connectivity threshold, provide, via a graphical user interface on the user device, the first network connectivity level of the bed to the user.

In some aspects, the techniques described herein relate to a system wherein providing, via the graphical user interface on the user device, the first network connectivity level of the bed to the user comprises providing a visual representation of the network connectivity level using a color.

In some aspects, the techniques described herein relate to a system wherein providing, via the graphical user interface on the user device, the first network connectivity level of the bed to the user comprises providing a graphical representation of the network connectivity level.

In some aspects, the techniques described herein relate to a system wherein receiving data indicating the first connectivity speed for the controller comprises receiving, from the server, data indicating connectivity speed for the controller on a periodic basis.

In some aspects, the techniques described herein relate to a system wherein receiving data indicating the first connectivity speed for the controller comprises receiving, from a server, data indicating connectivity speed for the controller in response to a command.

In some aspects, the techniques described herein relate to a system wherein the data indicating connectivity speed for the controller is based on a current connectivity speed for a router at a geographical location of the controller.

In another aspect, a system for performing a network diagnostic test includes a first server, the first server comprising a processor and a computer-readable memory, the first server configured to, receive, from a controller of a bed, one or more different types of data at one or more different times, determine a threshold period of time has elapsed since data was received from the controller of the bed, based on determining the threshold period of time has elapsed since data was received from the controller of the bed, initiate communication with a second server, based on initiating communication with the second server, receive, from the second server, data indicating a current connectivity speed for a router at a geographical location of the controller, responsive to receiving the data indicating the current connectivity speed for the router, determine a network connectivity level of the bed, responsive to determining the network connectivity level of the bed, compare the network connectivity level of the bed to a threshold level, and responsive to determining that (i) the threshold period of time has elapsed since data was received from the controller of the bed and (ii) that the network connectivity level of the bed exceeds the threshold level, communicate a notification to a help desk server to escalate a detected issue.

In some aspects, the techniques described herein relate to a system wherein the first server is further configured to provide the network connectivity level of the bed to a user associated with the bed.

In some aspects, the techniques described herein relate to a system wherein providing the connectivity level of the bed to the user associated with the bed comprises visually representing the network connectivity level using a color.

In some aspects, the techniques described herein relate to a system wherein providing the connectivity level of the bed to the user associated with the bed comprises visually representing the network connectivity level using a graphical representation.

In another implementation, a system includes a bed, and a controller operably connected to the bed, the controller including a processor and a computer-readable memory, the controller configured to receive, from a first server, a command to perform a test to determine a network connectivity level of the bed, responsive to receiving the command to perform the test to determine the network connectivity level of the bed, communicate with a second server, responsive to communicating with the second server, receive, from the second server, data indicating a current connectivity speed for a router, at a geographical location of the controller, wherein the router is in communication with the controller, and responsive to receiving the data indicating the current connectivity speed for the router, determine a network connectivity level of the bed using one or more set of rules.

In yet another implementation, a system includes a device and a server in communication with the device, the server including a processor and a computer-readable memory, the server configured to, at a first time, receive data indicating a first connectivity speed for the device, responsive to receiving data indicating the first connectivity speed for the device, determine a first network connectivity level of the device using one or more set of rules, compare the first network connectivity level of the device to a network connectivity threshold, responsive to comparing the first network connectivity level of the device to the connectivity threshold, determine that the first network connectivity level of the device meets the network connectivity threshold, at a second time, after the first time, receive data indicating a second connectivity speed for the device, responsive to receiving data indicating the second connectivity speed for the controller, determine a second network connectivity level of the device using the one or more set of rules, compare the second network connectivity level of the device to the network connectivity threshold, responsive to comparing the second networking connectivity level of the device to the connectivity threshold, determine that the second network connectivity level of the device does not meet the network connectivity threshold, and responsive to determining that the second network connectivity level of the device does not meet the network connectivity threshold, communicate a notification to a user device of a user associated with the device, wherein the notification indicates that the network connectivity level of the device is below the threshold and includes a recommendation to the user.

In another implementation, a system for performing a network diagnostic test includes a first server, the first server including a processor and a computer-readable memory, the first server configured to receive, from a device, one or more different types of data at one or more different times, determine a threshold period of time has elapsed since data was received from the device, based on determining the threshold period of time has elapsed since data was received from the device, initiate communication with a second server, based on initiating communication with the second server, receive, from the second server, data indicating a current connectivity speed for a router at a geographical location of the device, responsive to receiving the data indicating the current connectivity speed for the router, determine a network connectivity level of the device, responsive to determining the network connectivity level of the device, compare the network connectivity level of the device to a threshold level, and responsive to determining that (i) the threshold period of time has elapsed since data was received from the device and (ii) that the network connectivity level of the device exceeds the threshold level, communicate a notification to a help desk server to escalate a detected issue.

In some aspects, the techniques described herein relate to a system, wherein the first server is configured to receive, from the device, one or more different types of data at one or more different times by receiving bed pressure value data from a controller of a bed with a mattress that is configured to detect one or more pressure values, determine a threshold period of time has elapsed since bed pressure value data was received from the controller of the bed, based on determining the threshold period of time has elapsed since bed pressure value data was received from the controller of the bed, initiate communication with the second server, based on initiating communication with the second server, receive, from the second server, data indicating a current connectivity speed for a router at a geographical location of the controller of the bed, and responsive to receiving the data indicating the current connectivity speed for the router, determine a network connectivity level of the controller of the bed.

In some aspects, the techniques described herein relate to a system wherein the first server is configured to receive, from the device, one or more different types of data at one or more different times by receiving biometric data from a controller of a bed that is configured to capture one or more different types of biometric data, process the biometric data, and communicate the processed biometric data to the controller of the bed.

In some aspects, the techniques described herein relate to a system wherein the controller of the bed is configured to initiate a speed test to determine a network connectivity level of the bed based on determining that the processed biometric data is not received within a threshold period of time of communicating the biometric data to the first server.

The devices, system, and techniques described herein may provide one or more of the following advantages. For example, connectivity issues can be readily identified, and in some cases, proactively resolved without user input. For example, the root cause of the connectivity issue can be identified and resolved without having to rely on a warranty claim. For example, the system can determine whether the connectivity issue is being caused by the speed of the network at the location of the bed, or whether the issue is occurring between the bed and its network connection to the backend server.

The details of one or more implementations are set forth in the accompanying drawings and the description below. Other features, aspects and potential advantages will be apparent from the accompanying description and figures.

### DESCRIPTION OF DRAWINGS

FIG. 1 shows an example air bed system.

FIG. 2 is a block diagram of an example of various components of an air bed system.

FIG. 3 shows an example environment including a bed and one or more servers.

FIGS. 4 and 5 are examples of a system architecture for determining a connectivity level of a bed.

FIGS. 6 and 7 are example screenshots of a user interface.

FIG. 8 is an example process for determining the network connectivity level of the bed.

FIG. 9 is an example process for communicating a notification to a help desk server.

FIG. 10 is a schematic diagram that shows an example of a computing device and a mobile computing device.

Like reference symbols in the various drawings indicate like elements.

### DETAILED DESCRIPTION

This document describes configuring a bed to perform self-diagnostic testing to determine a strength of the connection between the bed and a backend server which supports the functions of the bed. For example, a pump at the bed can be configured to act as an internet hub, and can utilize one or more self-diagnosis protocols to determine a quality of the connection of the bed to the backend server that supports the bed’s functions.

### Example Airbed Hardware

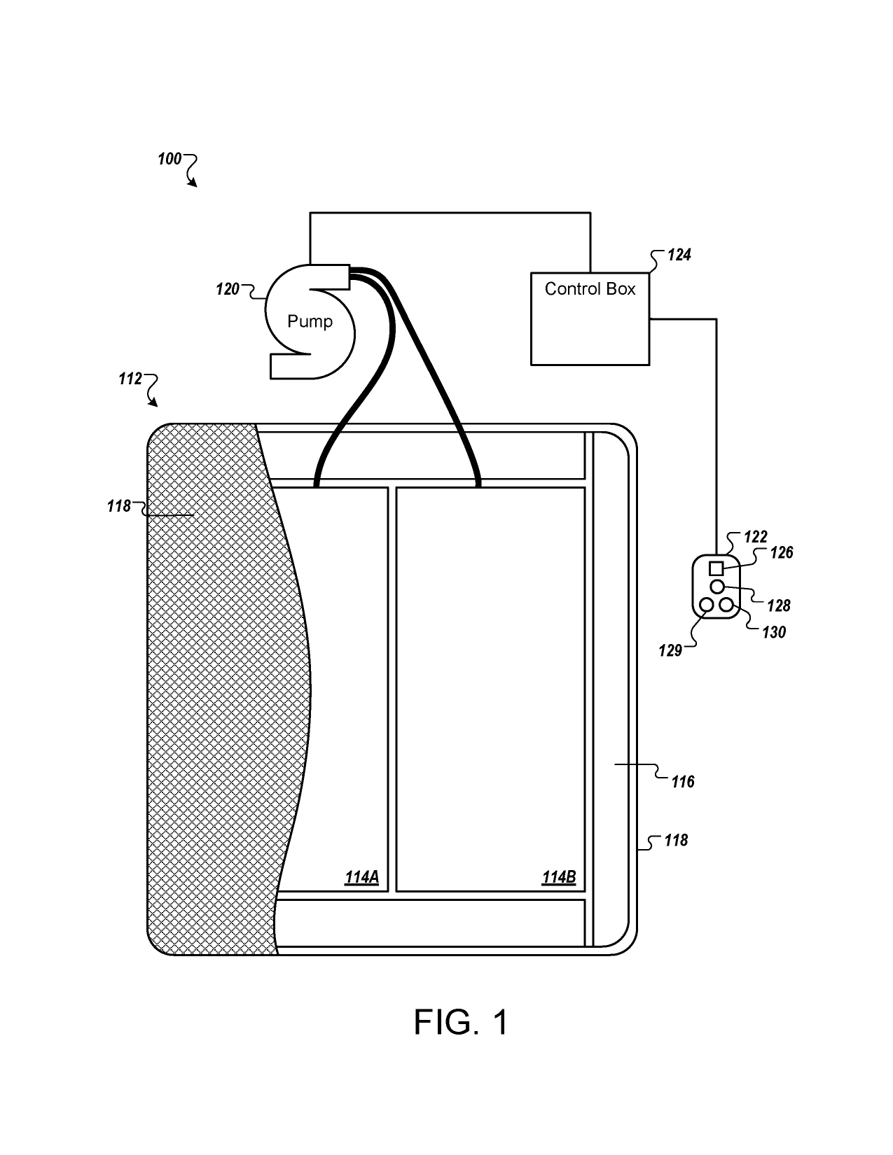

FIG. 1 shows an example air bed system 100 that includes a bed 112. The bed 112 can be a mattress that includes at least one air chamber 114 surrounded by a resilient border 116 and encapsulated by bed ticking 118. The resilient border 116 can comprise any suitable material, such as foam. In some embodiments, the resilient border 116 can combine with a top layer or layers of foam (not shown in FIG. 1) to form an upside-down foam tub. In other embodiments, mattress structure can be varied as suitable for the application.

As illustrated in FIG. 1, the bed 112 can be a two-chamber design having first and second fluid chambers, such as a first air chamber 114A and a second air chamber 114B. Sometimes, the bed 112 can include chambers for use with fluids other than air that are suitable for the application. For example, the fluids can include liquid. In some embodiments, such as single beds or kids’ beds, the bed 112 can include a single air chamber 114A or 114B or multiple air chambers 114A and 114B. Although not depicted, sometimes, the bed 112 can include additional air chambers. Other beds may not include any air chambers.

The first and second air chambers 114A and 114B can be in fluid communication with a pump 120. The pump 120 can be in electrical communication with a remote control 122 via control box 124. The control box 124 can include a wired or wireless communications interface for communicating with one or more devices, including the remote control 122. The control box 124 can be configured to operate the pump 120 to cause increases and decreases in the fluid pressure of the first and second air chambers 114A and 114B based upon commands input by a user using the remote control 122. In some implementations, the control box 124 is integrated into a housing of the pump 120. Moreover, sometimes, the pump 120 can be in wireless communication (e.g., via a home network, Wi-Fi, Bluetooth, or other wireless network) with a mobile device via the control box 124. The mobile device can include but is not limited to the user’s smartphone, cell phone, laptop, tablet, computer, wearable device, home automation device, or other computing device. A mobile application can be presented at the mobile device and provide functionality for the user to control the bed 112 and view information about the bed 112. The user can input commands in the mobile application presented at the mobile device. The inputted commands can be transmitted to the control box 124, which can operate the pump 120 based upon the commands.

The remote control 122 can include a display 126, an output selecting mechanism 128, a pressure increase button 129, and a pressure decrease button 130. The remote control 122 can include one or more additional output selecting mechanisms and/or buttons. The display 126 can present information to the user about settings of the bed 112. For example, the display 126 can present pressure settings of both the first and second air chambers 114A and 114B or one of the first and second air chambers 114A and 114B. Sometimes, the display 126 can be a touch screen, and can receive input from the user indicating one or more commands to control pressure in the first and second air chambers 114A and 114B and/or other settings of the bed 112.

The output selecting mechanism 128 can allow the user to switch air flow generated by the pump 120 between the first and second air chambers 114A and 114B, thus enabling control of multiple air chambers with a single remote control 122 and a single pump 120. For example, the output selecting mechanism 128 can by a physical control (e.g., switch or button) or an input control presented on the display 126. Alternatively, separate remote-control units can be provided for each air chamber 114A and 114B and can each include the ability to control multiple air chambers. Pressure increase and decrease buttons 129 and 130 can allow the user to increase or decrease the pressure, respectively, in the air chamber selected with the output selecting mechanism 128. Adjusting the pressure within the selected air chamber can cause a corresponding adjustment to the firmness of the respective air chamber. In some embodiments, the remote control 122 can be omitted or modified as appropriate for an application.

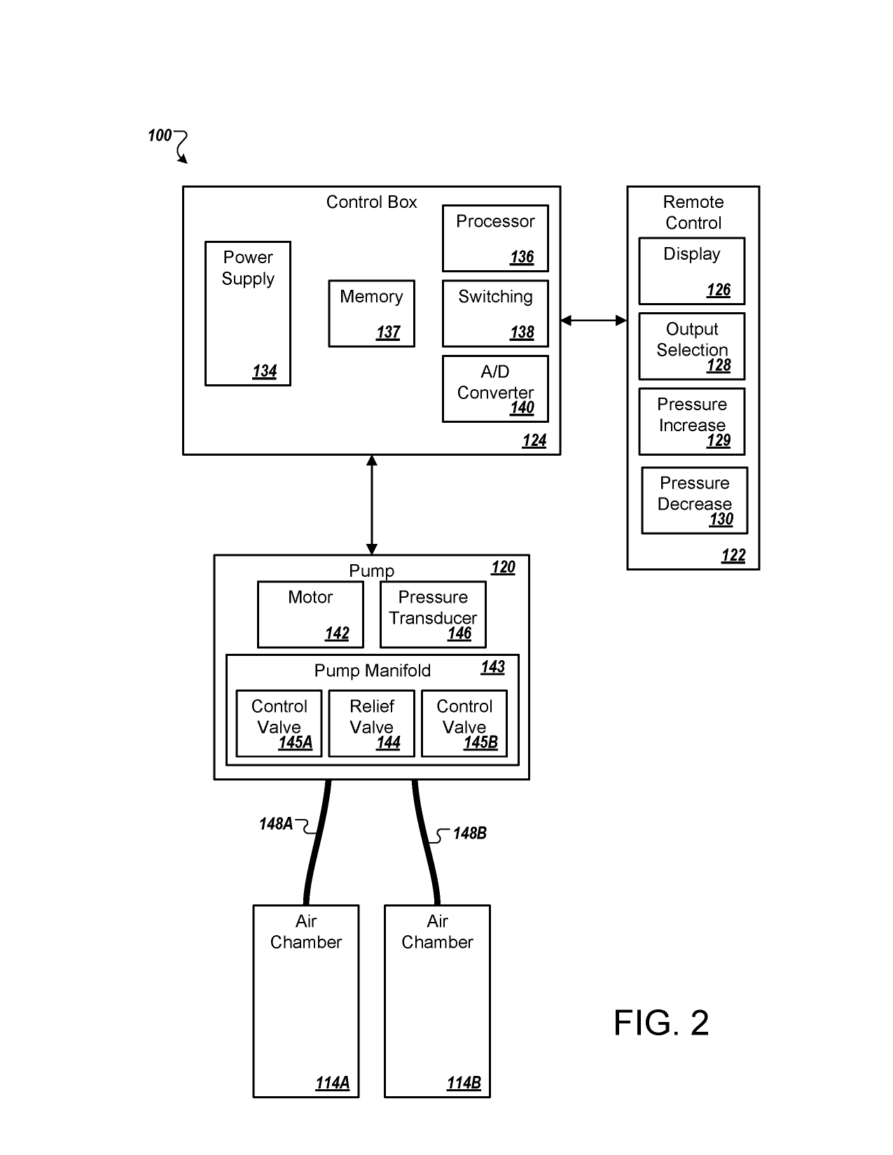

FIG. 2 is a block diagram of an example of various components of an air bed system. These components can be used in the example air bed system 100. The control box 124 can include a power supply 134, a processor 136, a memory 137, a switching mechanism 138, and an analog to digital (A/D) converter 140. The switching mechanism 138 can be, for example, a relay or a solid-state switch. In some implementations, the switching mechanism 138 can be located in the pump 120 rather than the control box 124. The pump 120 and the remote control 122 can be in two-way communication with the control box 124. The pump 120 includes a motor 142, a pump manifold 143, a relief valve 144, a first control valve 145A, a second control valve 145B, and a pressure transducer 146. The pump 120 is fluidly connected with the first air chamber 114A and the second air chamber 114B via a first tube 148A and a second tube 148B, respectively. The first and second control valves 145A and 145B can be controlled by switching mechanism 138, and are operable to regulate the flow of fluid between the pump 120 and first and second air chambers 114A and 114B, respectively.

In some implementations, the pump 120 and the control box 124 can be provided and packaged as a single unit. In some implementations, the pump 120 and the control box 124 can be provided as physically separate units. The control box 124, the pump 120, or both can be integrated within or otherwise contained within a bed frame, foundation, or bed support structure that supports the bed 112. Sometimes, the control box 124, the pump 120, or both can be located outside of a bed frame, foundation, or bed support structure (as shown in the example in FIG. 1).

The air bed system 100 in FIG. 2 includes the two air chambers 114A and 114B and the single pump 120 of the bed 112 depicted in FIG. 1. However, other implementations can include an air bed system having two or more air chambers and one or more pumps incorporated into the air bed system to control the air chambers. For example, a separate pump can be associated with each air chamber. As another example, a pump can be associated with multiple chambers. A first pump can be associated with air chambers that extend longitudinally from a left side to a midpoint of the air bed system 100 and a second pump can be associated with air chambers that extend longitudinally from a right side to the midpoint of the air bed system 100. Separate pumps can allow each air chamber to be inflated or deflated independently and/or simultaneously. Additional pressure transducers can also be incorporated into the air bed system 100 such that a separate pressure transducer can be associated with each air chamber.

As an illustrative example, in use, the processor 136 can send a decrease pressure command to one of air chambers 114A or 114B, and the switching mechanism 138 can convert the low voltage command signals sent by the processor 136 to higher operating voltages sufficient to operate the relief valve 144 of the pump 120 and open the respective control valve 145A or 145B. Opening the relief valve 144 can allow air to escape from the air chamber 114A or 114B through the respective air tube 148A or 148B. During deflation, the pressure transducer 146 can send pressure readings to the processor 136 via the A/D converter 140. The A/D converter 140 can receive analog information from pressure transducer 146 and can convert the analog information to digital information useable by the processor 136. The processor 136 can send the digital signal to the remote control 122 to update the display 126 to convey the pressure information to the user. The processor 136 can also send the digital signal to other devices in wired or wireless communication with the air bed system, including but not limited to mobile devices described herein. The user can then view pressure information associated with the air bed system at their device instead of at, or in addition to, the remote control 122.

As another example, the processor 136 can send an increase pressure command. The pump motor 142 can be energized in response to the increase pressure command and send air to the designated one of the air chambers 114A or 114B through the air tube 148A or 148B via electronically operating the corresponding valve 145A or 145B. While air is being delivered to the designated air chamber 114A or 114B to increase the chamber firmness, the pressure transducer 146 can sense pressure within the pump manifold 143. The pressure transducer 146 can send pressure readings to the processor 136 via the A/D converter 140. The processor 136 can use the information received from the A/D converter 140 to determine the difference between the actual pressure in air chamber 114A or 114B and the desired pressure. The processor 136 can send the digital signal to the remote control 122 to update display 126.

Generally speaking, during an inflation or deflation process, the pressure sensed within the pump manifold 143 can provide an approximation of the actual pressure within the respective air chamber that is in fluid communication with the pump manifold 143. An example method includes turning off the pump 120, allowing the pressure within the air chamber 114A or 114B and the pump manifold 143 to equalize, then sensing the pressure within the pump manifold 143 with the pressure transducer 146. Providing a sufficient amount of time to allow the pressures within the pump manifold 143 and chamber 114A or 114B to equalize can result in pressure readings that are accurate approximations of actual pressure within air chamber 114A or 114B. In some implementations, the pressure of the air chambers 114A and/or 114B can be continuously monitored using multiple pressure sensors (not shown). The pressure sensors can be positioned within the air chambers. The pressure sensors can also be fluidly connected to the air chambers, such as along the air tubes 148A and 148B.

In some implementations, information collected by the pressure transducer 146 can be analyzed to determine various states of a user laying on the bed 112. For example, the processor 136 can use information collected by the pressure transducer 146 to determine a heartrate or a respiration rate for the user. As an illustrative example, the user can be laying on a side of the bed 112 that includes the chamber 114A. The pressure transducer 146 can monitor fluctuations in pressure of the chamber 114A, and this information can be used to determine the user’s heartrate and/or respiration rate. As another example, additional processing can be performed using the collected data to determine a sleep state of the user (e.g., awake, light sleep, deep sleep). For example, the processor 136 can determine when the user falls asleep and, while asleep, the various sleep states (e.g., sleep stages) of the user. Based on the determined heartrate, respiration rate, and/or sleep states of the user, the processor 136 can determine information about the user’s sleep quality. The processor 136 can, for example, determine how well the user slept during a particular sleep cycle. The processor 136 can also determine user sleep cycle trends. Accordingly, the processor 136 can generate recommendations to improve the user’s sleep quality and overall sleep cycle. Information that is determined about the user’s sleep cycle (e.g., heartrate, respiration rate, sleep states, sleep quality, recommendations to improve sleep quality, etc.) can be transmitted to the user’s mobile device and presented in a mobile application, as described above.

Additional information associated with the user of the air bed system 100 that can be determined using information collected by the pressure transducer 146 includes user motion, presence on a surface of the bed 112, weight, heart arrhythmia, snoring, partner snore, and apnea. One or more other health conditions of the user can also be determined based on the information collected by the pressure transducer 146. Taking user presence detection for example, the pressure transducer 146 can be used to detect the user’s presence on the bed 112, e.g., via a gross pressure change determination and/or via one or more of a respiration rate signal, heartrate signal, and/or other biometric signals. Detection of the user’s presence can be beneficial to determine, by the processor 136, adjustment(s) to make to settings of the bed 112 (e.g., adjusting a firmness when the user is present to a user-preferred firmness setting) and/or peripheral devices (e.g., turning off lights when the user is present, activating a heating or cooling system, etc.).

For example, a simple pressure detection process can identify an increase in pressure as an indication that the user is present. As another example, the processor 136 can determine that the user is present if the detected pressure increases above a specified threshold (so as to indicate that a person or other object above a certain weight is positioned on the bed 112). As yet another example, the processor 136 can identify an increase in pressure in combination with detected slight, rhythmic fluctuations in pressure as corresponding to the user being present. The presence of rhythmic fluctuations can be identified as being caused by respiration or heart rhythm (or both) of the user. The detection of respiration or a heartbeat can distinguish between the user being present on the bed and another object (e.g., a suitcase, a pet, a pillow, etc.) being placed thereon.

In some implementations, pressure fluctuations can be measured at the pump 120. For example, one or more pressure sensors can be located within one or more internal cavities of the pump 120 to detect pressure fluctuations within the pump 120. The fluctuations detected at the pump 120 can indicate pressure fluctuations in the chambers 114A and/or 114B. One or more sensors located at the pump 120 can be in fluid communication with the chambers 114A and/or 114B, and the sensors can be operative to determine pressure within the chambers 114A and/or 114B. The control box 124 can be configured to determine at least one vital sign (e.g., heartrate, respiratory rate) based on the pressure within the chamber 114A or the chamber 114B.

The control box 124 can also analyze a pressure signal detected by one or more pressure sensors to determine a heartrate, respiration rate, and/or other vital signs of the user lying or sitting on the chamber 114A and/or 114B. More specifically, when a user lies on the bed 112 and is positioned over the chamber 114A, each of the user’s heart beats, breaths, and other movements (e.g., hand, arm, leg, foot, or other gross body movements) can create a force on the bed 112 that is transmitted to the chamber 114A. As a result of this force input, a wave can propagate through the chamber 114A and into the pump 120. A pressure sensor located at the pump 120 can detect the wave, and thus the pressure signal outputted by the sensor can indicate a heartrate, respiratory rate, or other information regarding the user.

With regard to sleep state, the air bed system 100 can determine the user’s sleep state by using various biometric signals such as heartrate, respiration, and/or movement of the user. While the user is sleeping, the processor 136 can receive one or more of the user’s biometric signals (e.g., heartrate, respiration, motion, etc.) and can determine the user’s present sleep state based on the received biometric signals. In some implementations, signals indicating fluctuations in pressure in one or both of the chambers 114A and 114B can be amplified and/or filtered to allow for more precise detection of heartrate and respiratory rate.

Sometimes, the processor 136 can receive additional biometric signals of the user from one or more other sensors or sensor arrays positioned on or otherwise integrated into the air bed system 100. For example, one or more sensors can be attached or removably attached to a top surface of the air bed system 100 and configured to detect signals such as heartrate, respiration rate, and/or motion. The processor 136 can combine biometric signals received from pressure sensors located at the pump 120, the pressure transducer 146, and/or the sensors positioned throughout the air bed system 100 to generate accurate and more precise information about the user and their sleep quality.

Sometimes, the control box 124 can perform a pattern recognition algorithm or other calculation based on the amplified and filtered pressure signal(s) to determine the user’s heartrate and/or respiratory rate. For example, the algorithm or calculation can be based on assumptions that a heartrate portion of the signal has a frequency in a range of 0.5-4.0 Hz and that a respiration rate portion of the signal has a frequency in a range of less than 1 Hz. Sometimes, the control box 124 can use one or more machine learning models to determine the user’s health information. The models can be trained using training data that includes training pressure signals and expected heartrates and/or respiratory rates. Sometimes, the control box 124 can determine user health information by using a lookup table that corresponds to sensed pressure signals.

The control box 124 can also be configured to determine other characteristics of the user based on the received pressure signal, such as blood pressure, tossing and turning movements, rolling movements, limb movements, weight, presence or lack of presence of the user, and/or the identity of the user.

For example, the pressure transducer 146 can be used to monitor the air pressure in the chambers 114A and 114B of the bed 112. If the user on the bed 112 is not moving, the air pressure changes in the air chamber 114A or 114B can be relatively minimal, and can be attributable to respiration and/or heartbeat. When the user on the bed 112 is moving, however, the air pressure in the mattress can fluctuate by a much larger amount. The pressure signals generated by the pressure transducer 146 and received by the processor 136 can be filtered and indicated as corresponding to motion, heartbeat, or respiration. The processor 136 can attribute such fluctuations in air pressure to the user’s sleep quality. Such attributions can be determined based on applying one or more machine learning models and/or algorithms to the pressure signals. For example, if the user shifts and turns a lot during a sleep cycle (for example, in comparison to historic trends of the user’s sleep cycles), the processor 136 can determine that the user experienced poor sleep during that particular sleep cycle.

In some implementations, rather than performing the data analysis in the control box 124 with the processor 136, a digital signal processor (DSP) can be provided to analyze the data collected by the pressure transducer 146. Alternatively, the collected data can be sent to a cloud-based computing system for remote analysis.

In some implementations, the example air bed system 100 further includes a temperature controller configured to increase, decrease, or maintain a temperature of the bed 112, for example for the comfort of the user. For example, a pad (e.g., mat, layer, etc.) can be placed on top of or be part of the bed 112, or can be placed on top of or be part of one or both of the chambers 114A and 114B. Air can be pushed through the pad and vented to cool off the user on the bed 112. Additionally or alternatively, the pad can include a heating element used to keep the user warm. In some implementations, the temperature controller can receive temperature readings from the pad. The temperature controller can determine whether the temperature readings are less than or greater than some threshold range and/or value. Based on this determination, the temperature controller can actuate components to push air through the pad to cool off the user or activate the heating element. In some implementations, separate pads are used for different sides of the bed 112 (e.g., corresponding to the locations of the chambers 114A and 114B) to provide for differing temperature control for the different sides of the bed 112. Each pad can be selectively controlled by the temperature controller to provide cooling or heating preferred by each user on the different sides of the bed 112. For example, a first user on a left side of the bed 112 can prefer to have their side of the bed 112 cooled during the night while a second user on a right side of the bed 112 can prefer to have their side of the bed 112 warmed during the night.

In some implementations, the user of the air bed system 100 can use an input device, such as the remote control 122 or a mobile device as described above, to input a desired temperature for a surface of the bed 112 (or for a portion of the surface of the bed 112, for example at a foot region, a lumbar or waist region, a shoulder region, and/or a head region of the bed 112). The desired temperature can be encapsulated in a command data structure that includes the desired temperature and also identifies the temperature controller as the desired component to be controlled. The command data structure can then be transmitted via Bluetooth or another suitable communication protocol (e.g., WiFi, a local network, etc.) to the processor 136. In various examples, the command data structure is encrypted before being transmitted. The temperature controller can then configure its elements to increase or decrease the temperature of the pad depending on the temperature input provided at the remote control 122 by the user.

In some implementations, the temperature of the surface of the bed may be controlled remotely through a remote cloud server. The remote cloud server may be configured to receive and store sensor data associated with the bed system. The remote cloud server may include a network interface, a communication manager, server hardware, and server system software. The remote server may include a sensor manager for each sensor in the bed. The remote cloud server can also store historical readings or reports from the environmental sensors in the bed. For example, the cloud server can store temperate settings selected by a user during a sleep cycle. The remote cloud server can be accessed at a later time and used by one or more cloud services described herein to determine sleep quality and/or health information of the users. The remote cloud server can include reports generated based on stored data. For example, the remote cloud server can generate and retain a report indicating frequency and duration of instances of increased temperature when the user is asleep based on stored temperature sensor data. The remote cloud server may communicate a desired temperature for the surface of the bed based on the stored data. The temperature of the surface of the bed can be adjusted based on the desired temperature determined from the stored temperature data. For example, the temperature of the surface of the bed can be heated or cooled to meet the desired temperature based on the stored data.

In some implementations, data can be transmitted from a component back to the processor 136 or to one or more display devices, such as the display 126 of the remote controller 122. For example, the current temperature as determined by a sensor element of a temperature controller, the pressure of the bed, the current position of the foundation or other information can be transmitted to control box 124. The control box 124 can transmit this information to the remote control 122 to be displayed to the user (e.g., on the display 126). As described above, the control box 124 can also transmit the received information to a mobile device to be displayed in a mobile application or other graphical user interface (GUI) to the user.

In some implementations, the example air bed system 100 further includes an adjustable foundation and an articulation controller configured to adjust the position of the bed 112 by adjusting the adjustable foundation supporting the bed. For example, the articulation controller can adjust the bed 112 from a flat position to a position in which a head portion of a mattress of the bed is inclined upward (e.g., to facilitate a user sitting up in bed and/or watching television). The bed 112 can also include multiple separately articulable sections. As an illustrative example, the bed 112 can include one or more of a head portion, a lumbar/waist portion, a leg portion, and/or a foot portion, all of which can be separately articulable. As another example, portions of the bed 112 corresponding to the locations of the chambers 114A and 114B can be articulated independently from each other, to allow one user positioned on the bed 112 surface to rest in a first position (e.g., a flat position or other desired position) while a second user rests in a second position (e.g., a reclining position with the head raised at an angle from the waist or another desired position). Separate positions can also be set for two different beds (e.g., two twin beds placed next to each other). The foundation of the bed 112 can include more than one zone that can be independently adjusted.

Sometimes, the bed 112 can be adjusted to one or more user-defined positions based on user input and/or user preferences. For example, the bed 112 can automatically adjust, by the articulation controller, to one or more user-defined settings. As another example, the user can control the articulation controller to adjust the bed 112 to one or more user-defined positions. Sometimes, the bed 112 can be adjusted to one or more positions that may provide the user with improved or otherwise improve sleep and sleep quality. For example, a head portion on one side of the bed 112 can be automatically articulated, by the articulation controller, when one or more sensors of the air bed system 100 detect that a user sleeping on that side of the bed 112 is snoring. As a result, the user’s snoring can be mitigated so that the snoring does not wake up another user sleeping in the bed 112.

In some implementations, the bed 112 can be adjusted using one or more devices in communication with the articulation controller or instead of the articulation controller. For example, the user can change positions of one or more portions of the bed 112 using the remote control 122 described above. The user can also adjust the bed 112 using a mobile application or other graphical user interface presented at a mobile computing device of the user.

The articulation controller can also provide different levels of massage to one or more portions of the bed 112 for one or more users. The user(s) can adjust one or more massage settings for the portions of the bed 112 using the remote control 122 and/or a mobile device in communication with the air bed system 100.

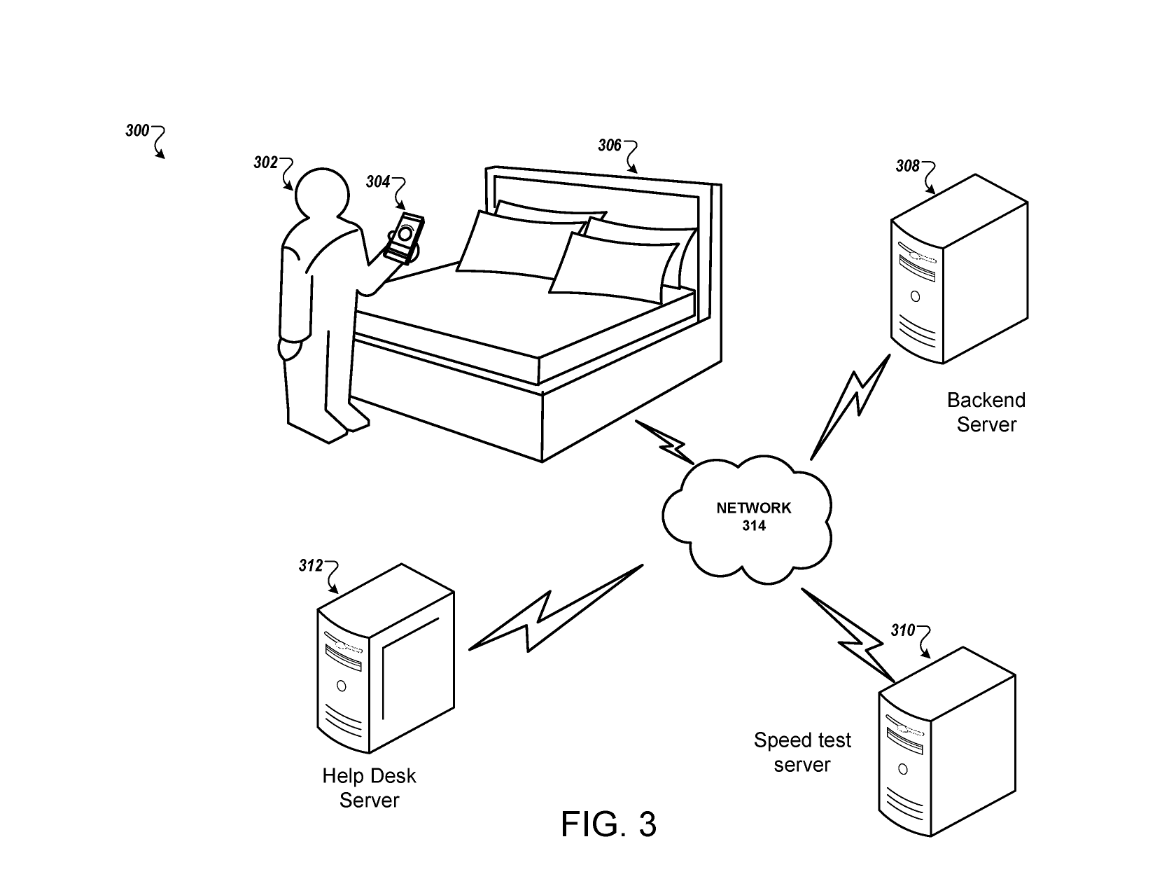

FIG. 3 shows an example environment 300 including a bed and one or more servers. As shown in FIG. 1, a user 302 of a bed 306 may have user device 304 that is configured to display data associated with data collected by one or more components within the bed 306. The network 314 facilitates communication between element of the system including the control box 124 at the bed 306, a backend server 308, a speed test server 310, a help desk server 312, and the user electronic device 304. The user device 304 may host and display user interfaces. The user device 304 may include a cell phone, a smart phone, a tablet PC, a personal digital assistant (“PDA”), or any other portable device configured to communicate over a network and display information. The user device 304 can include a sleep monitoring application, the sleep monitoring application refers to a software/firmware program running on the corresponding mobile device that enables the user interface and features described throughout.

The user 302 may utilize the sleep monitoring application on the user device 304 to initiate a speed test to determine the network connectivity level of their bed 306. The speed test is used to establish the quality of the internet connection between the bed 306 and the backend server 308 that supports the functionality of the bed 306. The network connectivity level of the bed 306 can include a numerical value that represents the quality of the internet connection between the bed 306 and the backend server 308. The user 302 may decide to initiate the speed test when the user 302 has not received updated data from the backend server 308 that supports the functionality of the bed 306. For example, the user 302 may notice that their sleep monitoring data has not been updated in a few days. In some implementations, during the initial installation of a bed 306, a technician that is installing the bed 306 can initiate a speed test to confirm that the network connectivity level of the newly installed bed 306 is above a threshold network connectivity level to support the functionality of the bed 306.

In some implementations, the backend server 308 may command the control box 124 at the bed 306 to perform a speed test to determine the network connectivity level of the bed 306. For example, the backend server 308 may command the control box 124 at the bed 306 to perform a speed test periodically. In some implementations, when the backend server 308 commands the control box 124 at the bed to perform a speed test periodically, the backend server 308 may save in memory the time of the speed test and the results of the speed test. In other implementations, the backend server 308 may command the control box 124 at the bed 306 to perform a speed test to determine the connectivity level of the bed when the control box 124 determines that the bed 306 timed out while performing a function.

When a speed test is initiated, the backend server 308 may initiate communication with a speed test speed test server 310. The speed test server 310 is a server than can run speed tests to establish the quality of the internet connection for one or more different clients (not shown). The speed test server 310 may be configured to determine the network speed of an internet service provider (ISP) that services the geographical location where the bed 306 is located. For example, the speed test server 310 may determine the network speed for the router at the location of the bed 306. The speed test server 310 may receive real-time connectivity speed data for the router at the location of the bed 306. In some implementations, the connectivity may be measured as the upload/download speed to the speed test server 310. The speed test server 310 may communicate the connectivity speed data for the router at the location of the bed 306 to the backend server 308 and or to the control box 124 at the bed 306.

The network connectivity level of the bed 306 can be established either by the control box 124 of the bed 306 or by the backend server 308 that supports the functionality of the bed 306. In some implementations, the control box 124 at the bed 306 is configured to determine a network connectivity level of the bed 306 using one or more set of rules. In these implementations, the control box 124 at the bed 306 may receive the connectivity speed data of the router that is connected to the control box 124 from the speed test server 310, and may utilize one or more algorithms to ascertain a network connectivity level of the bed 306 based on the connectivity speed data. The controller at the bed 306 may utilize a scoring model that utilizes statistical techniques, such as, regression analysis, factor analysis, machine learning algorithms, or any other suitable type of analysis. In some implementations, the network connectivity level of the bed 306 may be determined based on utilizing a weighted average score of the current and a second connectivity speed data. For example, the control box 124 at the bed 306 may receive second connectivity speed data at a second time after the current time, and may use a weighted average to determine the network connectivity level of the bed 306. In some implementations, the network connectivity level of the bed 306 may be determined based on utilizing a normalization method. In some implementations, the network connectivity level of the bed 306 may be determined based on a percentile.

In some implementations, the backend server 308 is configured to determine the network connectivity level of the bed 306. In these implementations, the backend server 308 may receive the connectivity speed data from the speed test server 310, and may utilize one or more algorithms to determine the network connectivity level of the bed 306. The determined network connectivity level of the bed 306 may be displayed to the user 302 through a user interface of the sleep monitoring application on the user device 304.

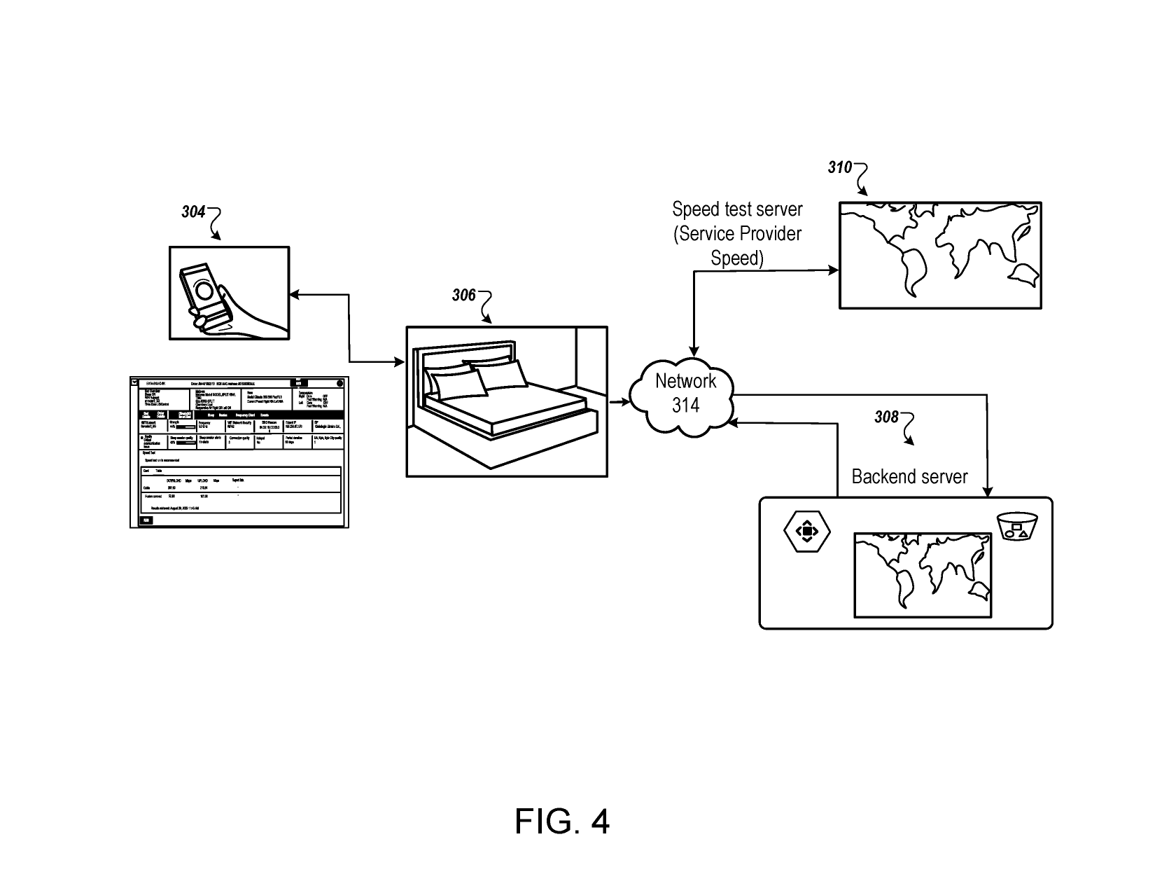

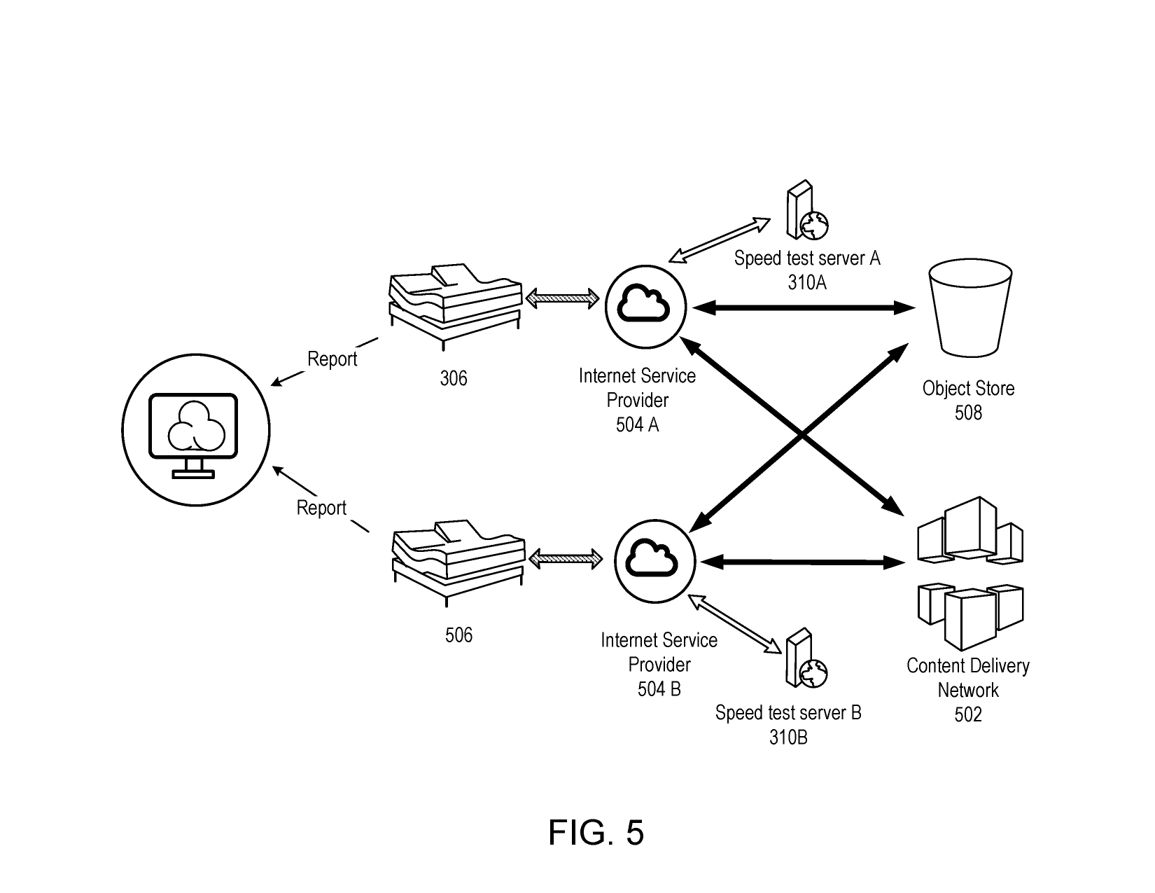

FIGS. 4 and 5 are examples of a system architecture for determining a connectivity level of a bed. As illustrated in FIG. 4, the system includes a user device 304, a bed 306, a speed test server 310 which provides service provider speed data, and a backend server 308. As described with reference to FIG. 3, the network 314 facilitates communication between the control box 124 at the bed 306, the backend server 308, and the speed test server 310. The user device 304 may host and display user interfaces through the sleep monitoring application which is supported by the backend server 308.

As illustrated in FIG. 5, one or more beds 306 and 506 may be in communication with the backend server 308. Each of the one or more beds 306 and 506 may be located in different geographic locations. For example, bed 306 may be located at House A in Florida and bed 506 may be located at House B in Texas. Each of the one or more beds 306 and 506 may be serviced by a specific internet service providers 504A and 504B, respectively.

When a technician at a help desk initiates a speed test to determine the network connectivity speed a bed 306, the backend server 308 may initiate communication with a speed test server 310A or 310B based on the geographical location of the bed and the server. For example, the backend server 308 communicates with the speed test server that is closest to its geographical location. The speed test server 310A is the server that is in communication with the internet server provider 502 that provides service to the router that is located in the geographic location of bed 306. The internet service provider 504A and 504B may be in communication with a content delivery network 502. The content delivery network (CDN) 502 is a distributed network of servers that are each strategically positioned in various locations across the globe to deliver web content more efficiently to users. The CDN network helps to minimize latency, accelerate content delivery, and improve overall performance by reducing the distance between the user and the content they are accessing. The internet service provider 504 may be in communication with an object store 508. The object store 508 is a data storage that manages data as objects.

When a user of the bed 506 initiates a speed test, the backend server 308 communicates with the speed test server 310B that is closest to the location of the internet service provider 504A and/or 504B that provides service to the location of the bed 506. The speed test server 310B provides the network connectivity level for the router at the location of the bed to the backend server to determine connectivity level of the bed 506.

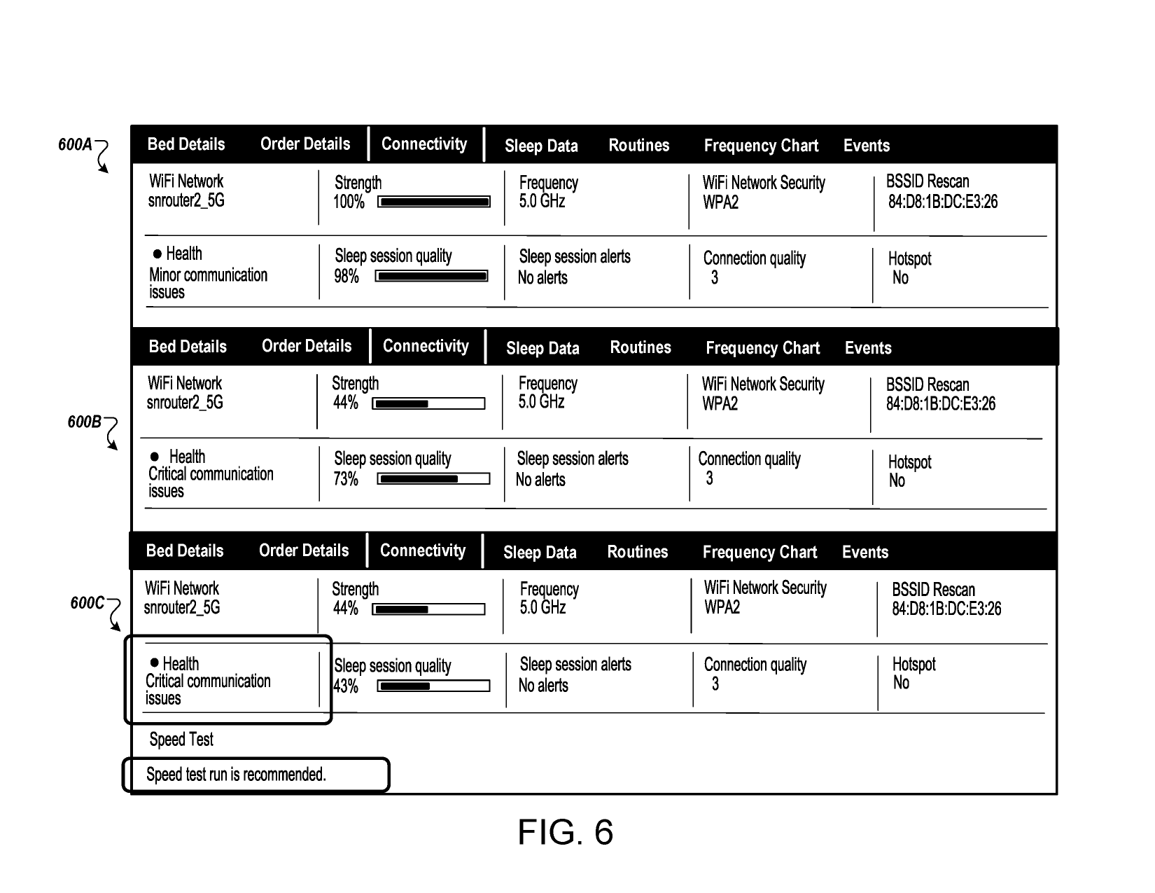

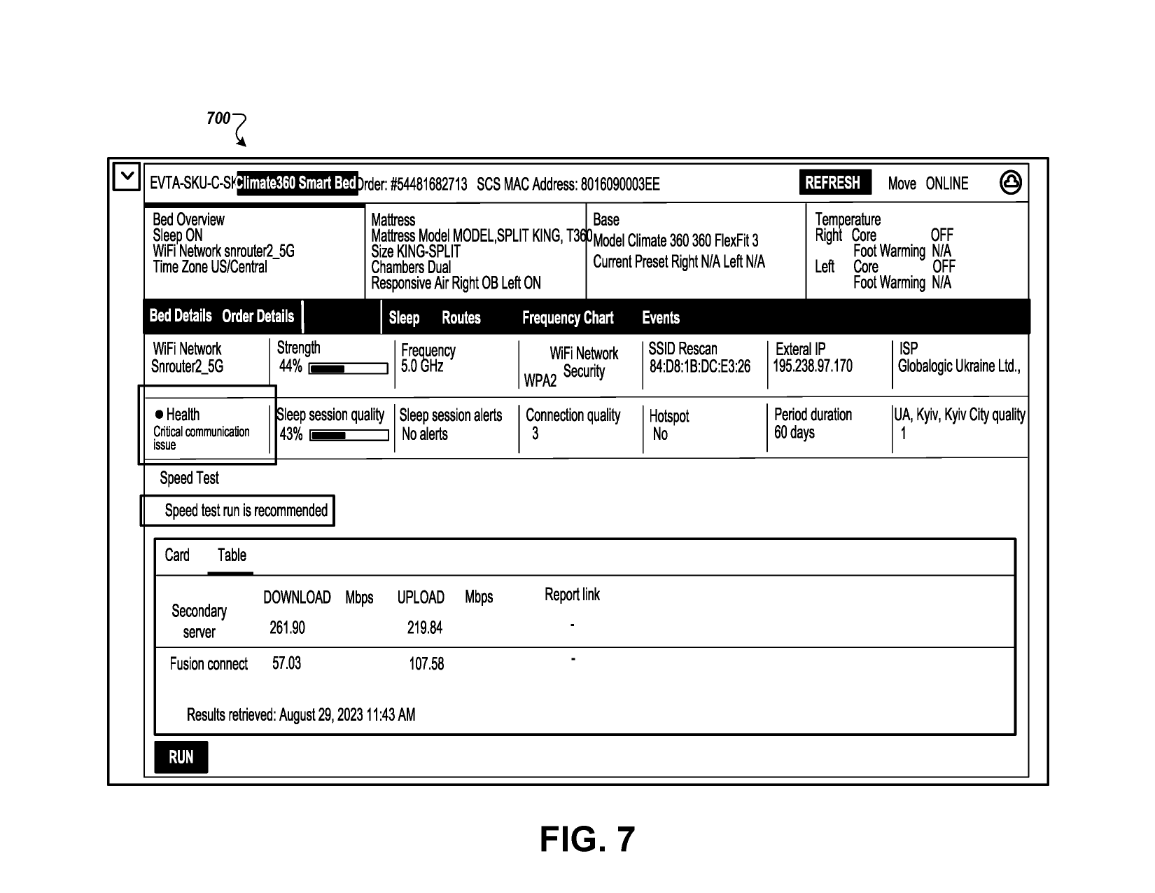

FIGS. 6 and 7 are example screenshots of user interfaces 600 and 700 that can be used by a worker at a help desk. The help desk can provide a service to trouble shoot issues faced by the one or more users that own beds that are supported by the backend server 308. The help desk can be supported by the help desk server 312 and can be in communication with the backend server 308 over the network 314. As illustrated in FIG. 6, each of the user interfaces 600A. 600B, and 600C may include bed details, connectivity of the bed, sleep data, frequency chart, and events. The user interfaces 600A, 600B, and 600C visually represent the network connectivity level of the bed using one or more different colors, or through graphical representation. For example, in interface 600A, the Wi-Fi network strength is determined to be 100%, and can be represented by a green line indicator (color not shown) that uses the full length of the line indicator to represent that the network strength is 100%. In some examples, when the Wi-Fi network strength is above a threshold strength, the indicator is represented by a green indicator. In these examples, when the Wi-Fi strength is below the threshold strength, the indicator is represented by a red indicator. In some implementations, the user interface includes a sleep session quality indicator, the sleep session quality indicator represents the network connectivity of the controller at the bed during a detected sleep session. A sleep session may be an uninterrupted period of time that the user is detected as being in the bed asleep. For example, a sleep session may include a nap during the day from a first time to a second time. For another example, a sleep session may include an full night of sleep. In some implementations, any particular time or period of time can be used, and the sleep session quality indicator may then represent the network connectivity of the controller of the bed during the time or period of time. As illustrated in user interface 600A, a green line indicator (color not shown) is used to indicate that the network connectivity of the controller at the bed during a detected sleep session is 98%. The user interface 600A indicates that the overall health of the bed is good based on the Wi-Fi strength being at 100% and the sleep session quality being 98%. In some examples, a green circle (color not shown) can be used to indicate that the health of the bed is satisfactory.

As illustrated in 600B, the Wi-Fi network strength is 44% and a red line indicator is used to indicate that the Wi-Fi network strength is below the network threshold strength. The sleep sessions quality is 73% and a purple line indicator is used to indicate that the network strength during the detected sleep session is mediocre. Based on the Wi-Fi network strength being below the threshold strength and the sleep session quality being average, the overall health of the bed is average (the overall health of the bed can be a weighted average of the Wi-Fi network strength and the sleep session quality), and a blue circle (color not shown) is used to indicate the status. In some implementations, the overall health of the bed can be a combination of the Wi-Fi network strength and the sleep session quality.

As illustrated in 600C, both the Wi-Fi strength and the sleep session quality are below threshold values and a red line indicator is used to indicate strength. Based on both qualities being thresholds the overall health of the bed is critical, and a red circle indicator is used to indicate to the user. The user interface 600C may include a recommendation to perform a speed test run, and may include an icon that can be selected by the user 302 to initiate the speed test.

As illustrated in FIG. 7, user interface 700 may include a tab for the results received when a speed test is run. As illustrated, the user interface includes a run icon that when selected by the user initiates a speed test. The speed test data indicates the upload and the download speeds from the secondary server and the fusion connect upload and download speeds. The user can be a help desk technician, or the user can be a bed owner.

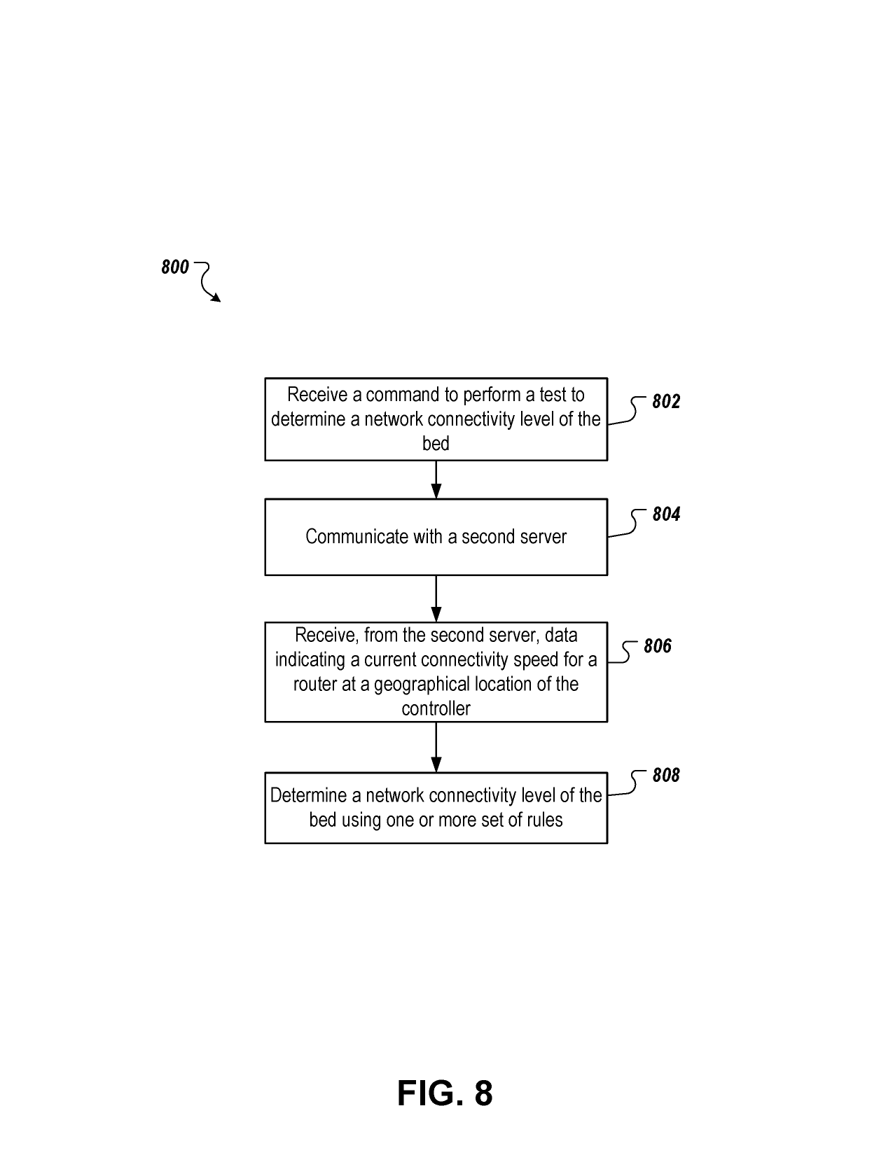

FIG. 8 is a flow chart illustrating a process 800 for determining a network connectivity level of the bed using one or more set of rules. Briefly, the process 800 may include receiving a command to perform a test to determine a network connectivity level of the bed (802), communicating with a speed test server (804), receiving, from the speed test server, data indicating a current connectivity speed for a router at a geographical location of the controller (806), and determining a network connectivity level of the bed using one or more set of rules (808).

In more detail, process 800 may include receiving a command to perform a test to determine a network connectivity level of the bed (802). For example, this may include the control box 124 at the bed 306 receiving a command from the backend server 308 that supports the functionality of the bed 306 to perform a connectivity test. In some implementations, the control box 124 at the bed 306 may receive the command to perform the connectivity test from the backend server 308 on a periodic basis. For example, the control box 124 at the bed 306 may receive the command to perform the connectivity test once a day, once a week, once a month, or any other suitable period. In some implementations, the control box 124 at the bed 306 may receive the command to perform the connectivity test at random time periods. In some implementations, the control box 124 at the bed 306 may receive the command to perform the connectivity test from the backend server 308 in response to the backend server 308 detecting a connectivity issue. For example, the backend server 308 may detect a connectivity issue when a threshold period of time has elapsed since the backend server 308 received data from the control box 124 at the bed 306. In some implementations, a user 302 may initiate a speed test through the sleep monitoring application on their user device 304.

The process 800 may include communicating with a speed test server (804). For example, this may include the backend server 308 initiating communication with a speed test server 310 that is configured to determine a network speed from a service provider that services the geographical location where the bed 306 is located. In some implementations, the speed test server 310 continuously provides data that indicates the network speed from the service provider in the location where the bed 306 is located to the backend server 308. In other implementations, the speed test server 310 provides this data when the backend server 308 specifically requests the data.

The process 800 may include receiving from the speed test server, data indicating a current connectivity speed for a router at a geographical location of the control box 124 (806). For example, this may include the backend server 308 receiving real-time connectivity speed data for the geographical location of the control box 124 at the bed 306. The real-time connectivity data may be specific to a router at the geographical location of the bed 306 and that is in communication with the control box 124 at the bed 306. In some implementations, the speed test server 310 may communicate data indicating the current connectivity speed for the router, and then may communicate data the connectivity speed for the router at a second later time. For example, the speed test server 310 may communicate the connectivity speed for the router at the current time, and then the speed in ten minutes. In some implementations, the speed test server 310 may determine the connectivity speed for the router over a period of time, and communicate an average connectivity speed to the backend server 308. For example, the speed test server 310 may determine the connectivity speed for the router at the time of receiving the request from the backend server 308, and determine the connectivity speed at a second time after the request, and at a third time after the second time, and the speed test server 310 may determine the average connectivity speed and provide the average connectivity speed data to the backend server 308.

The process 800 may include determining a network connectivity level of the bed 306 using one or more set of rules (808). For example, this may include the control box 124 at the bed 306 utilizing one or more algorithms to determine a network connectivity level of the bed 306 based on the current connectivity speed received from the speed test server 310. The control box 124 at the bed 306 may utilize a scoring model that utilizes statistical techniques, such as, regression analysis, factor analysis, machine learning algorithms, or any other suitable type of analysis. The control box 124 at the bed 306 communicates the network connectivity level of the bed 306 to the backend server 308. The backend server 308 may use the network connectivity level data and other data to generate and output one or more graphical interfaces that display the data. For example, as illustrated in FIG. 6 and FIG. 7, the backend server 308 may output interfaces that indicate the network connectivity level of the bed 306, and may categorize whether the network connectivity level is strong or weak.

In some implementations, the control box 124 at the bed 306 communicates the network connectivity level of the bed 306 to the backend server 308, and the backend server 308 compares the network connectivity level to a network connectivity threshold. The backend server 308 may provide a recommendation to the user 302 associated with the bed 306 when the network connectivity level is below the network connectivity threshold. For example, the backend server 308 may provide a notification to the user device 304 of the user 302 indicating that the user 302 should refresh their network connection. In some implementations, the backend server 308 may provide the recommendation through the graphical interface of the sleep monitoring application on the user device 304.

In some implementations, the backend server 308 continuously receives connectivity speed data for the control box 124 at the bed 306. For example, the backend server 308 may receive connectivity speed data for the router in communication with the control box 124 at the bed 306 at multiple times a week, a month, or any other suitable time period. The backend server 308 may communicate the connectivity speed data to the control box 124 at the bed 306, and the control box 124 may determine a current network connectivity level for the bed 306. In some implementations, the backend server 308 is configured to determine the network connectivity level based on the connectivity speed data received from the speed test server 310. In these implementations, the backend server 308 may utilize one or more algorithms to determine the network connectivity level for the bed. In implementations where the control box 124 at the bed 306 determines the network connectivity level for the bed 306, the control box 124 may compare the network connectivity level for the bed 306 to a network connectivity threshold to determine whether the network connectivity level for the control box 124 at the bed 306 is sufficient to facilitate reliable communication with the backend server 308. In the implementations where the backend server 308 determines the network connectivity level of the control box 124 at the bed 306, the backend server 308 may compare the network connectivity level for the bed 306 to the network connectivity threshold.

When the network connectivity level of the bed 306 meets the connectivity threshold, the control box 124 at the bed 306 and or the backend server 308 does not take any action. When the network connectivity level of the bed 306 does not meet the connectivity threshold, the control box 124 at the bed 306 may communicate a notification to a user device 304 of the user 302. The notification may indicate that the network connectivity level of the bed 306 is below the threshold and may include a recommendation to the user 302. For example, the notification may include a recommendation to the user 302 to reset a router at the location. For example, the notification may include a recommendation to the user 302 to move the location of the router.

In some implementations, when the backend server 308 determines that the network connectivity level of the bed 306 meets the network connectivity threshold, the backend server 305 may communicate a test communication to the control box 124 at the bed 306. When the backend server 308 determines that the test communication to the control box 124 failed, that is the backend server 308 is not able to communicate with the control box 124, the backend server may 308 communicate a notification to the help desk server 312. The notification to the help desk server 312 may indicate that the connectivity level of the bed 306 meets the network connectivity threshold, but the backend server 308 is still not able to connect to the control box 124 at the bed 306. This indication that the control box 124 has a sufficient connectivity level, yet the bed 306 is unable to communicate with the backend server 308 may demonstrate that a more complex issue is occurring. The help desk server 312 may receive the communication from the backend server 308 and initiate a help desk ticket in an attempt to trouble shoot the issue.

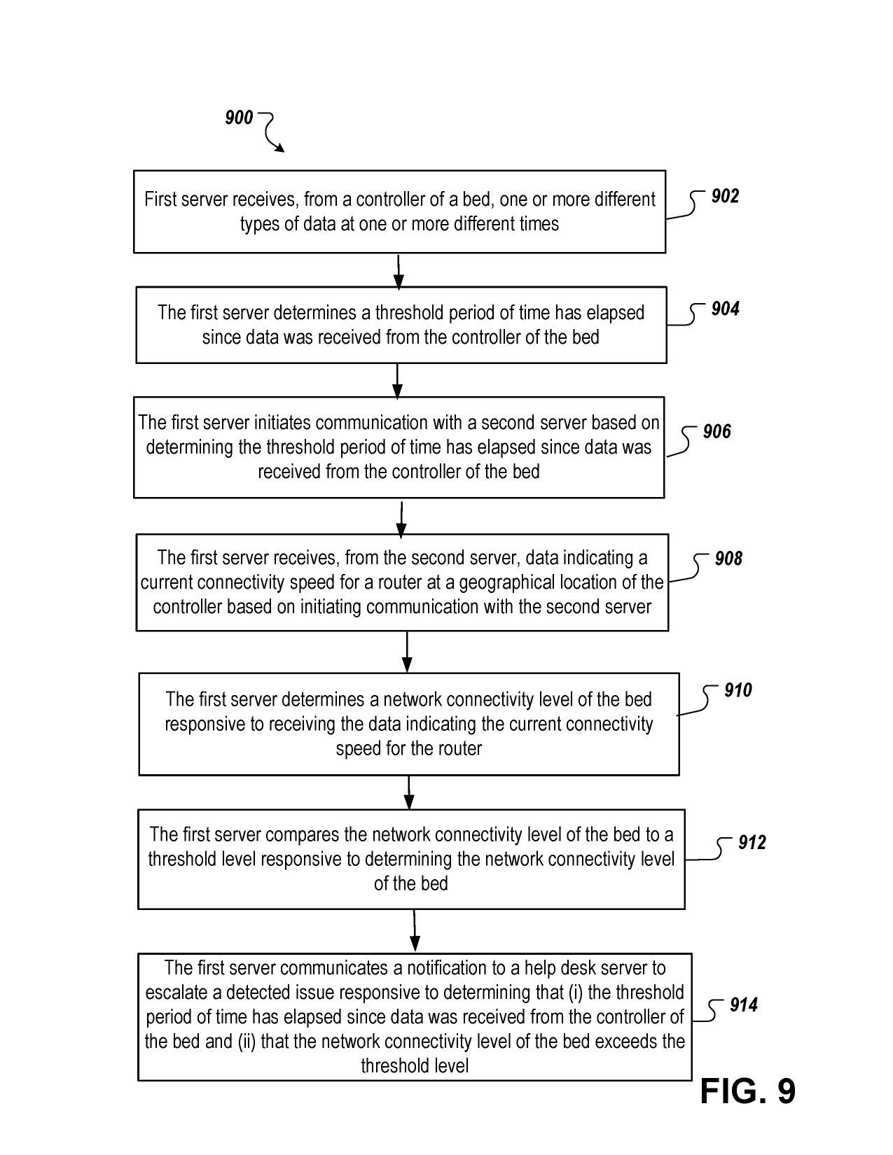

FIG. 9 is a flow chart illustrating a process 900 for communicating a notification to a help desk server to escalate a detected issue. Briefly, the process 900 may include a first server, that includes a processor and a computer-readable memory, receiving from a controller of a bed, one or more different types of data at one or more different times (902), the first server determining a threshold period of time has elapsed since data was received from the controller of the bed (904), the first server initiating communication with a speed test server based on determining the threshold period of time has elapsed since data was received from the controller of the bed (906), the first server receiving from the speed test server, data indicating a current connectivity speed for a router at a geographical location of the controller (908), the first server determining a network connectivity level of the bed responsive to receiving the data indicating the current connectivity speed for the router (910), the first server comparing the network connectivity level of the bed to a threshold level responsive to determining the network connectivity level of the bed (912), and the first server communicating a notification to a help desk server to escalate a detected issue responsive to determining that (i) the threshold period of time has elapsed since data was received from the controller of the bed and (ii) that the network connectivity level of the bed exceeds the threshold level (914).

In more detail, process 900 may include a first server, that includes a processor and a computer-readable memory, receiving from a controller of a bed, one or more different types of data at one or more different times (902). For example, this may include a first server receiving sleep quality data associated with a user 302 of a bed 306. For example, this may include the first server receiving heart rate data associated with the user 302 of the bed 306. The first server may be a server that is configured to support the functionality of the bed. For example, the first server can be the backend server 308. The first server may receive data at different times during the day and night. For example, the first server may receive data when the user 302 is sleeping in the bed 306, such as heart rate data.

The first server determines a threshold period of time has elapsed since data was received from the controller of the bed (904). The first server may be configured to determine when the server has last received data from the control box 124 of the bed 306. For example, the first server can determine that it has not received data from the control box 124 of the bed 306 in 24 hours, in a week, in a month, or any other suitable period.

The first server initiates communication with a speed test server based on determining the threshold period of time has elapsed since data was received from the controller of the bed (906). For example, this may involve the first server initiating communication with a speed test server 310 that is located in close proximity to the router of the bed 306. The speed test server 310 may be in communication with the internet service provider that services the geographical location of the router that the bed 306 is connected to.

The first server receives, from the speed test server, data indicating a current connectivity speed for a router at a geographical location of the controller based on initiating communication with the speed test server (908). For example, this may involve the first server receiving real-time connectivity speed data for the router at the geographical location of the bed 306. The connectivity speed may be measured as the upload/download speed.

The first server determines a network connectivity level of the bed responsive to receiving the data indicating the current connectivity speed for the router (910). The first server may receive the connectivity speed data from the speed test server 310, and may utilize one or more algorithms to calculate the network connectivity level of the bed 306. For example, the first server may utilize a scoring model that uses statistical techniques, such as, regression analysis, factor analysis, machine learning algorithms, or any other suitable type of analysis to calculate the network connectivity level of the bed 306.

The first server compares the network connectivity level of the bed to a threshold level responsive to determining the network connectivity level of the bed (912). For example, the first server compares the calculated network connectivity level of the bed 306 to a threshold connectivity level. The threshold connectivity level can be a threshold connectivity speed that would allow each of the one or more functions of the bed to be supported optimally.

The first server communicates a notification to a help desk server to escalate a detected issue responsive to determining that (i) the threshold period of time has elapsed since data was received from the controller of the bed and (ii) that the network connectivity level of the bed exceeds the threshold level (914). For example, the first server may communicate a notification to the help desk server 312 indicating that the connectivity level of the bed 306 exceeds the network connectivity threshold, but the first server still has not received data from the controller of the bed 306. This situation can indicate that a more complex issue is occurring. The help desk server 312 may receive the communication from the first server and initiate a help desk ticket in an attempt to trouble shoot the issue.

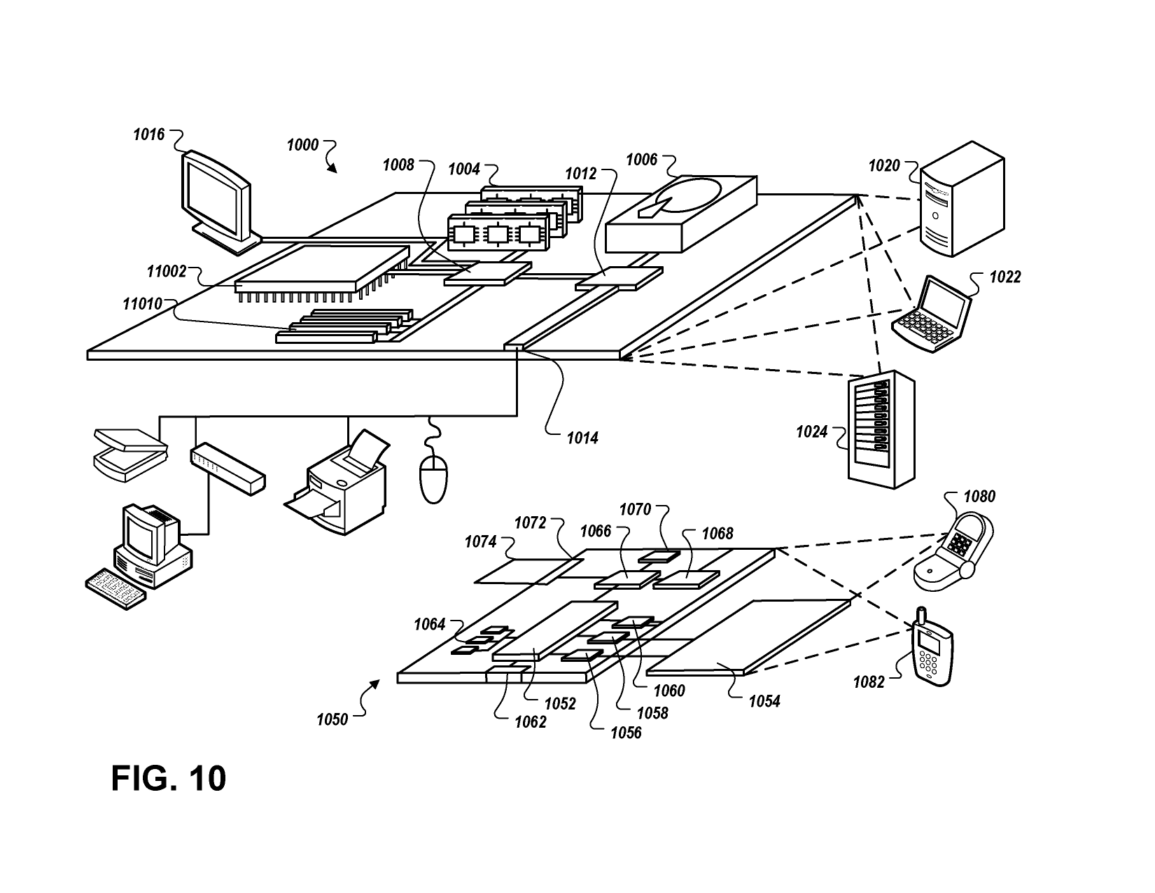

FIG. 10 shows an example of a computing device 1000 and an example of a mobile computing device that can be used to implement the techniques described here. The computing device 1000 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 1000 includes a processor 1002, a memory 1004, a storage device 1006, a high-speed interface 1008 connecting to the memory 1004 and multiple high-speed expansion ports 1010, and a low-speed interface 1012 connecting to a low-speed expansion port 1014 and the storage device 1006. Each of the processor 1002, the memory 1004, the storage device 11006, the high-speed interface 1008, the high-speed expansion ports 1010, and the low-speed interface 1012, are interconnected using various busses, and can be mounted on a common motherboard or in other manners as appropriate. The processor 1002 can process instructions for execution within the computing device 1000, including instructions stored in the memory 1004 or on the storage device 1006 to display graphical information for a GUI on an external input/output device, such as a display 1016 coupled to the high-speed interface 1008. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system). The memory 1004 stores information within the computing device 1000. In some implementations, the memory 1004 is a volatile memory unit or units. In some implementations, the memory 1004 is a non-volatile memory unit or units. The memory 1004 can also be another form of computer-readable medium, such as a magnetic or optical disk. The storage device 1006 is capable of providing mass storage for the computing device 1000. In some implementations, the storage device 1006 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 1004, the storage device 1006, or memory on the processor 1002.

The high-speed interface 1008 manages bandwidth-intensive operations for the computing device 1000, while the low-speed interface 1012 manages lower bandwidth-intensive operations. Such allocation of functions is exemplary only. In some implementations, the high-speed interface 1008 is coupled to the memory 1004, the display 1016 (e.g., through a graphics processor or accelerator), and to the high-speed expansion ports 1010, which can accept various expansion cards (not shown). In the implementation, the low-speed interface 1012 is coupled to the storage device 1006 and the low-speed expansion port 1014. The low-speed expansion port 1014, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter. The computing device 1000 can be implemented in a number of different forms, as shown in the figure. For example, it can be implemented as a standard server 1020, or multiple times in a group of such servers. In addition, it can be implemented in a personal computer such as a laptop computer 1022. It can also be implemented as part of a rack server system 1024. Alternatively, components from the computing device 1000 can be combined with other components in a mobile device (not shown), such as a mobile computing device 1050. Each of such devices can contain one or more of the computing device 1000 and the mobile computing device 1050, and an entire system can be made up of multiple computing devices communicating with each other. The mobile computing device 1050 includes a processor 1052, a memory 1064, an input/output device such as a display 1054, a communication interface 1066, and a transceiver 1068, among other components. The mobile computing device 1050 can also be provided with a storage device, such as a micro-drive or other device, to provide additional storage. Each of the processor 1052, the memory 1064, the display 1054, the communication interface 1066, and the transceiver 1068, are interconnected using various buses, and several of the components can be mounted on a common motherboard or in other manners as appropriate.

The processor 1052 can execute instructions within the mobile computing device 1050, including instructions stored in the memory 1064. The processor 1052 can be implemented as a chipset of chips that include separate and multiple analog and digital processors. The processor 1052 can provide, for example, for coordination of the other components of the mobile computing device 1050, such as control of user interfaces, applications run by the mobile computing device 1050, and wireless communication by the mobile computing device 1050. The processor 1052 can communicate with a user through a control interface 1058 and a display interface 1056 coupled to the display 1054. The display 1054 can be, for example, a TFT (Thin-Film-Transistor Liquid Crystal Display) display or an OLED (Organic Light Emitting Diode) display, or other appropriate display technology. The display interface 1056 can comprise appropriate circuitry for driving the display 1054 to present graphical and other information to a user. The control interface 1058 can receive commands from a user and convert them for submission to the processor 1052. In addition, an external interface 1062 can provide communication with the processor 1052, so as to enable near area communication of the mobile computing device 1050 with other devices. The external interface 1062 can provide, for example, for wired communication in some implementations, or for wireless communication in other implementations, and multiple interfaces can also be used.

The memory 1064 stores information within the mobile computing device 1050. The memory 1064 can be implemented as one or more of a computer-readable medium or media, a volatile memory unit or units, or a non-volatile memory unit or units. An expansion memory 1074 can also be provided and connected to the mobile computing device 1050 through an expansion interface 1072, which can include, for example, a SIMM (Single In Line Memory Module) card interface. The expansion memory 1074 can provide extra storage space for the mobile computing device 1050, or can also store applications or other information for the mobile computing device 1050. Specifically, the expansion memory 1074 can include instructions to carry out or supplement the processes described above, and can include secure information also. Thus, for example, the expansion memory 1074 can be provide as a security module for the mobile computing device 1050, and can be programmed with instructions that permit secure use of the mobile computing device 1050. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 1064, the expansion memory 1074, or memory on the processor 1052. In some implementations, the computer program product can be received in a propagated signal, for example, over the transceiver 11068 or the external interface 1062.

The mobile computing device 1050 can communicate wirelessly through the communication interface 1066, which can include digital signal processing circuitry where necessary. The communication interface 1066 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1068 using a radio-frequency. In addition, short-range communication can occur, such as using a Bluetooth, Wi-Fi, or other such transceiver (not shown). In addition, a GPS (Global Positioning System) receiver module 1070 can provide additional navigation- and location-related wireless data to the mobile computing device 1050, which can be used as appropriate by applications running on the mobile computing device 1050. The mobile computing device 1050 can also communicate audibly using an audio codec 1060, which can receive spoken information from a user and convert it to usable digital information. The audio codec 1060 can likewise generate audible sound for a user, such as through a speaker, e.g., in a handset of the mobile computing device 1050. Such sound can include sound from voice telephone calls, can include recorded sound (e.g., voice messages, music files, etc.) and can also include sound generated by applications operating on the mobile computing device 1050. The mobile computing device 1050 can be implemented in a number of different forms, as shown in the figure. For example, it can be implemented as a cellular telephone 1080. It can also be implemented as part of a smart-phone 1082, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input. The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet. The computing system can include clients and servers. A client and server are generally remote from each other and typically interact through a communication network. The relationship of client and server arises by virtue of computer programs running on the respective computers and having a client-server relationship to each other.

The foregoing detailed description and some embodiments have been given for clarity of understanding only. No unnecessary limitations are to be understood therefrom. It will be apparent to those skilled in the art that many changes can be made in the embodiments described without departing from the scope of the invention. For example, a different order and type of operations may be used to generate classifiers. Additionally, a bed system may aggregate output from classifiers in different ways. Thus, the scope of the present invention should not be limited to the exact details and structures described herein, but rather by the structures described by the language of the claims, and the equivalents of those structures. Any feature or characteristic described with respect to any of the above embodiments can be incorporated individually or in combination with any other feature or characteristic, and are presented in the above order and combinations for clarity only.

A number of embodiments of the inventions have been described. Nevertheless, it will be understood that various modifications can be made without departing from the spirit and scope of the invention. For example, in some embodiments the bed need not include adjustable air chambers. Additionally, different aspects of the different embodiments of foundations, mattresses, and other bed system components described above can be combined while other aspects as suitable for the application. Accordingly, other embodiments are within the scope of the following claims.

What is claimed is:

1. A system comprising:
a bed; and
a controller operably connected to the bed, the controller comprising a processor and a computer-readable memory, the controller configured to:
receive, from a first server, a command to perform a test to determine a network connectivity level of the bed;
responsive to receiving the command to perform the test to determine the network connectivity level of the bed, communicate with a second server;
responsive to communicating with the second server, receive, from the second server, data indicating a current connectivity speed for a router at a geographical location of the controller, wherein the router is in communication with the controller; and
responsive to receiving the data indicating the current connectivity speed for the router, determine a network connectivity level of the bed using one or more set of rules.

2. The system of claim 1, wherein, receiving, from the first server, the command to perform a test to determine a network connectivity level of the bed comprises receiving a periodic command to perform the test.

3. The system of claim 1, wherein, receiving, from the first server, the command to perform a test to determine a network connectivity level of the bed comprises receiving a command to perform the test in response to detecting a connectivity issue.

4. The system of claim 1, further comprising:
communicating the network connectivity level of the bed to the first server, the first server being configured to:
compare the network connectivity level of the bed to a network connectivity threshold;
responsive to comparing the network connectivity level of the bed to a network connectivity threshold, determine that the network connectivity level is below the network connectivity threshold; and
responsive to determining that the network connectivity level is below the network connectivity threshold, provide a recommendation to a user.

5. The system of claim 4, wherein the first server is configured to provide the network connectivity level of the bed to the user.

6. The system of claim 5, wherein providing the network connectivity level of the bed to the user comprises visually representing the network connectivity level using multiple colors.

7. The system of claim 5, wherein providing the network connectivity level of the bed to the user comprises visually representing the network connectivity level using a graphical representation.

8. A system comprising:
a bed;
a controller connected to the bed; and
a server in communication with the controller, the server comprising a processor and a computer-readable memory, the server configured to:
at a first time:
receive data indicating a first connectivity speed for the controller;
responsive to receiving data indicating the first connectivity speed for the controller, determine a first network connectivity level of the bed using at least one of one or more set of rules;
compare the first network connectivity level of the bed to a network connectivity threshold;
responsive to comparing the first network connectivity level of the bed to the connectivity threshold, determine that the first network connectivity level of the bed meets the network connectivity threshold;
at a second time, after the first time:
receive data indicating a second connectivity speed for the controller;
responsive to receiving data indicating the second connectivity speed for the controller, determine a second network connectivity level of the bed using the at least one of the one or more set of rules;
compare the second network connectivity level of the bed to the network connectivity threshold;
responsive to comparing the second network connectivity level of the bed to the connectivity threshold, determine that the second network connectivity level of the bed does not meet the network connectivity threshold; and
responsive to determining that the second network connectivity level of the bed does not meet the network connectivity threshold, communicate a notification to a user device of a user associated with the bed, wherein the notification indicates that the network connectivity level of the bed is below the threshold and includes a recommendation to the user.

9. The system of claim 8, further comprising:
responsive to determining that the first network connectivity level of the bed meets the network connectivity threshold, initiate a test communication with the controller;
responsive to initiating the test communication with the controller, determine that the server is not connecting to the controller; and
responsive to determining that the server is not connecting to the controller, communicate a notification to a help desk server indicating that the connectivity level of the bed meets the network connectivity threshold but the server is not connecting to the controller.

10. The system of claim 8, wherein communicating a notification to the user device of the user associated with the bed, including the recommendation to the user, comprises communicating a notification recommending the user to reset a router at a geographical location of the bed.

11. The system of claim 8, wherein communicating a notification to the user device of the user associated with the bed, including the recommendation to the user, comprises communicating a notification recommending the user move a location of a router at a geographical location of the bed.

12. The system of claim 8, further comprising:
responsive to determining that the first network connectivity level of the bed meets the network connectivity threshold, provide, via a graphical user interface on the user device, the first network connectivity level of the bed to the user.

13. The system of claim 12, wherein providing, via the graphical user interface on the user device, the first network connectivity level of the bed to the user comprises providing a visual representation of the first network connectivity level using a color.

14. The system of claim 12, wherein providing, via the graphical user interface on the user device, the first network connectivity level of the bed to the user comprises providing a graphical representation of the first network connectivity level.

15. The system of claim 8, wherein receiving data indicating the first connectivity speed for the controller comprises receiving, from the server, data indicating connectivity speed for the controller on a periodic basis.

16. The system of claim 8, wherein receiving data indicating the first connectivity speed for the controller comprises receiving, from a server, data indicating connectivity speed for the controller in response to a command.

17. The system of claim 8, wherein the data indicating connectivity speed for the controller is based on a current connectivity speed for a router at a geographical location of the controller.

18. A system for performing a network diagnostic test comprising:
a first server, the first server comprising a processor and a computer-readable memory, the first server configured to:
receive, from a controller of a bed, one or more different types of data at one or more different times;
determine a threshold period of time has elapsed since data was received from the controller of the bed;
based on determining the threshold period of time has elapsed since data was received from the controller of the bed, initiate communication with a second server;
based on initiating communication with the second server, receive, from the second server, data indicating a current connectivity speed for a router at a geographical location of the controller;
responsive to receiving the data indicating the current connectivity speed for the router, determine a network connectivity level of the bed;
responsive to determining the network connectivity level of the bed, compare the network connectivity level of the bed to a threshold level; and
responsive to determining that (i) the threshold period of time has elapsed since data was received from the controller of the bed and (ii) that the network connectivity level of the bed exceeds the threshold level, communicate a notification to a help desk server to escalate a detected issue.

19. The system of claim 18, wherein the first server is further configured to:
provide the network connectivity level of the bed to a user associated with the bed.

20. The system of claim 19, wherein providing the network connectivity level of the bed to the user associated with the bed comprises visually representing the network connectivity level using at least one of a color and a graphical representation.
